(19) United States
(12) Patent Application Publication
(10) Pub. No.: US 2012/0260174 A1
(43) Pub. Date: Oct. 11, 2012

(54) REPRODUCTION APPARATUS AND FILMMAKING SYSTEM

(76) Inventors: Hideyuki Imaida, Tokyo (JP); Shinichi Tsuda, Kanagawa (JP)

(21) Appl. No.: 13/433,545

(22) Filed: Mar. 29, 2012

(30) Foreign Application Priority Data
Apr. 7, 2011 (JP) 2011-085343

(51) Int. Cl. G06F 3/048

(52) U.S. Cl. 715/721

(57) ABSTRACT

A reproduction apparatus includes: a reproduction unit configured to reproduce, from a recording medium that records a video signal, the video signal; a first GUI supplying unit configured to supply first GUI data to a terminal apparatus connected via a network, the first GUI data being data for causing a user to select an arbitrary scene in the reproduced video signal and color modulation information applied to the scene; and a metadata processing unit configured to perform color modulation of the selected scene with the selected color modulation information to thereby create an image as a snapshot, and to store metadata in a server apparatus connected via the network, the metadata including access information necessary to access the snapshot.

### BACKGROUND

The present disclosure relates to a reproduction apparatus configured to reproduce a video signal from a recording medium such as a tape, and a filmmaking system including the reproduction apparatus.

In the field of filmmaking such as a cinema, an image-shooting gamma (for example, S-Log gamma or the like) is sometimes used during image shooting on the assumption that the image quality is to be adjusted after image shooting. This kind of image-shooting gamma is designed in a nonlinear function so as to be capable of taking more shadow/highlight information. By taking more shadow/highlight information, it is possible to increase degrees of freedom of color correction in a postproduction work.

In a case of outputting an S-Log video on a monitor that executes processing in a linear space, as it is, the S-Log video is displayed as a dark picture. Therefore, the S-Log video is displayed through a viewing LUT for converting the S-Log video to the linear space and through a monitor LUT for indicating gamma characteristic of the monitor. As a result, colors of the S-Log video are reproduced on a monitor. Further, in the field of filmmaking, a director views an S-Log video via a monitor, and instructs a color-grading editor in postproduction to use colors that the director decided.

However, an environment in which the director views the S-Log video is sometimes different from an environment in which the color-grading editor views the S-Log video in color modulation information such as a viewing LUT and a monitor LUT. In such a case, hues of colors of a video displayed on monitors of both environments are different from each other. So there may be a fear that colors decided by a director are not reflected on edit works accurately.

According to Japanese Patent No. 4363468 (paragraph 0036) (hereinafter, referred to as Patent Document 1), a simulation-gamma-correction parameter and a video signal to be recorded are transmitted to postproduction processing as the next step. The simulation-gamma-correction parameter is used for simulation when shooting a video to which postproduction processing is performed.

However, the technology according to the above-mentioned Patent Document 1 employs a system of transmitting a simulation-gamma-correction parameter together with a video signal to be recorded. Therefore, a simulation-gamma-correction parameter may be added only at the timing of image shooting. So the technology of Patent Document 1 is unsuitable for the following purposes. That is, a director determines color modulation information on a video already took and recorded, and the color modulation information is transmitted to an edit environment. Further, the technology according to the above-mentioned Patent Document 1 has a limitation that, for example, it is only one simulation-gamma-correction parameter that may be added to a video signal. This point can be a barrier to improve efficiency in filmmaking.

### SUMMARY

In view of the above-mentioned circumstances, it is desirable to provide a reproduction apparatus and a filmmaking system capable of improve efficiency in filmmaking.

According to an aspect of the present technology, there is provided a reproduction apparatus, including: a reproduction unit configured to reproduce, from a recording medium that records a video signal, the video signal; a first GUI supplying unit configured to supply first GUI data to a terminal apparatus connected via a network, the first GUI data being data for causing a user to select an arbitrary scene in the reproduced video signal and color modulation information applied to the scene; and a metadata processing unit configured to perform color modulation of the selected scene with the selected color modulation information to thereby create an image as a snapshot, and to store metadata in a server apparatus connected via the network, the metadata including access information necessary to access the snapshot.

According to the present technology, the terminal apparatus is capable of selecting an arbitrary scene in a video signal recorded in a recording medium and color modulation information applied to the scene. Further, metadata including access information to a snapshot of a video scene subjected to color modulation by using the color modulation information is stored in the server apparatus. Therefore, a user of an apparatus capable of accessing the server apparatus may refer to metadata as needed. As a result, for example, a user who edits a video signal refers to metadata stored in the server apparatus, whereby the editing apparatus may easily provide an environment for reproducing a snapshot that a user of the terminal apparatus have viewed via a monitor. As a result, it is possible to accurately reflect the decision of the user of the terminal apparatus on color grading of a video signal by the editing apparatus.

The reproduction apparatus according to the present technology may further include a second. GUI supplying unit configured to obtain the metadata stored in the server apparatus via the network, to obtain a snapshot based on the access information included in the obtained metadata, to create second GUI data including the snapshot, and to supply the second GUI data to the terminal apparatus.

Further, the metadata may further include information identifying an LUT (Look up Table) of a monitor of the terminal apparatus. Therefore, by matching an LUT of a second monitor in an edit environment to the LUT of a first monitor of the terminal apparatus, the editing apparatus is capable of easily generating an environment for reproducing a snapshot that a user of the terminal apparatus have viewed via a monitor.

The metadata may further include a user name of the terminal apparatus, and information on a priority of a user, and the second GUI supplying unit may be configured to create, in a case of obtaining a plurality of pieces of metadata of a plurality of users, second GUI data in a display mode to which priorities of the plurality of users are added.

The second GUI data may include a comment input box in which a user may input a comment, and the reproduction apparatus may further include a comment processing unit configured to obtain a comment input to the comment input box, and to upload the comment to the server apparatus so as to add the comment to the metadata. Therefore it is possible to add a comment by a user to metadata, and to exchange the comment with another user.

The reproduction apparatus according to the present technology may further include a third GUI supplying unit configured to supply third GUI data to the terminal apparatus, the third GUI data having an environment causing the user to create new color modulation information.

The reproduction apparatus according to the present technology may further include a fourth GUI supplying unit configured to supply, in a case where an arbitrary scene is selected in the terminal apparatus by the user, fourth GUI data to the terminal apparatus, the fourth GUI data having an environment for editing and sending email to an editing apparatus configured to edit the video signal, the email previously including at least a first URL link to the snapshot and a second URL link to the color modulation information selected so as to be applied to the scene. Therefore the editing apparatus is capable of easily obtaining a snapshot and color modulation information by using URL links provided in the email, and it is possible to accurately and easily reflect the decision of a user of the terminal apparatus on color grading of a video signal by the editing apparatus.

According to another aspect of the present technology, there is provided a filmmaking system, including: a reproduction apparatus including a reproduction unit configured to reproduce, from a recording medium that records a video signal, the video signal, and to create a file of the video signal; a terminal apparatus connected to the reproduction apparatus via a network; a server apparatus capable of storing the file of the video signal created by the reproduction apparatus; and an editing apparatus configured to obtain the file of the video signal stored in the server apparatus, and to edit the video signal. The reproduction apparatus includes a GUI supplying unit configured to supply first GUI data to the terminal apparatus, the first GUI data being data for causing a user to select an arbitrary scene in the reproduced video signal and color modulation information applied to the scene, and a metadata processing unit configured to perform color modulation of the selected scene with the selected color modulation information to thereby create an image as a snapshot, and. to store metadata in a server apparatus connected via the network, the metadata including access information necessary to access the snapshot. The terminal apparatus includes a monitor configured to display the first GUI data supplied from the reproduction apparatus, and an input unit configured to accept selection by the user.

As described above, according to the present technology, efficiency in filmmaking may be improved.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing the configuration of a filmmaking system according to a first embodiment of the present technology;

FIG. 2 is a diagram showing the configuration of a file-transfer module and part of the configuration of a VTR of the filmmaking system of the first embodiment;

FIG. 3 is an external view showing a terminal apparatus of the filmmaking system of the first embodiment;

FIG. 4 is a block diagram showing the hardware configuration of the terminal apparatus of FIG. 3;

FIG. 5 is a diagram showing homepages displayed in the terminal apparatus of FIG. 3;

FIG. 6 is a diagram showing the homepage, a VTR Setup window, and an LUT menu window displayed in the terminal apparatus of FIG. 3;

FIG. 7 is s diagram showing a Cineon LUT window displayed in the terminal apparatus of FIG. 3;

FIG. 8 is a diagram showing a Custom LUT window displayed in the terminal apparatus of FIG. 3;

FIG. 9 is a diagram showing a Monitor window displayed in the terminal apparatus of FIG. 3;

FIG. 10 is a diagram showing a Cassette menu window, a Cassette information window, and a Clip List window displayed in the terminal apparatus of FIG. 3;

FIG. 11 is a diagram showing Disk Setup windows displayed in the terminal apparatus of FIG. 3;

FIG. 12 is a diagram showing a VTR Viewer window and a VTR Viewer setup window displayed in the terminal apparatus of FIG. 3;

FIG. 13 is a diagram showing a VTR Viewer window, a VTR Viewer window on which a pop-up is displayed, and an email sending window displayed in the terminal apparatus of FIG. 3;

FIG. 14 is a diagram showing Snap-List windows displayed in the terminal apparatus of FIG. 3;

FIG. 15 is a diagram showing a Snap-Info window displayed in the terminal apparatus of FIG. 3;

FIG. 16 is a diagram showing an example of a Snap XML; and

FIG. 17 is a sequential diagram showing behaviors of the filmmaking system of the first embodiment.

### DETAILED DESCRIPTION OF EMBODIMENTS

Hereinafter, an embodiment of the present disclosure will be described with reference to the drawings.

### First Embodiment

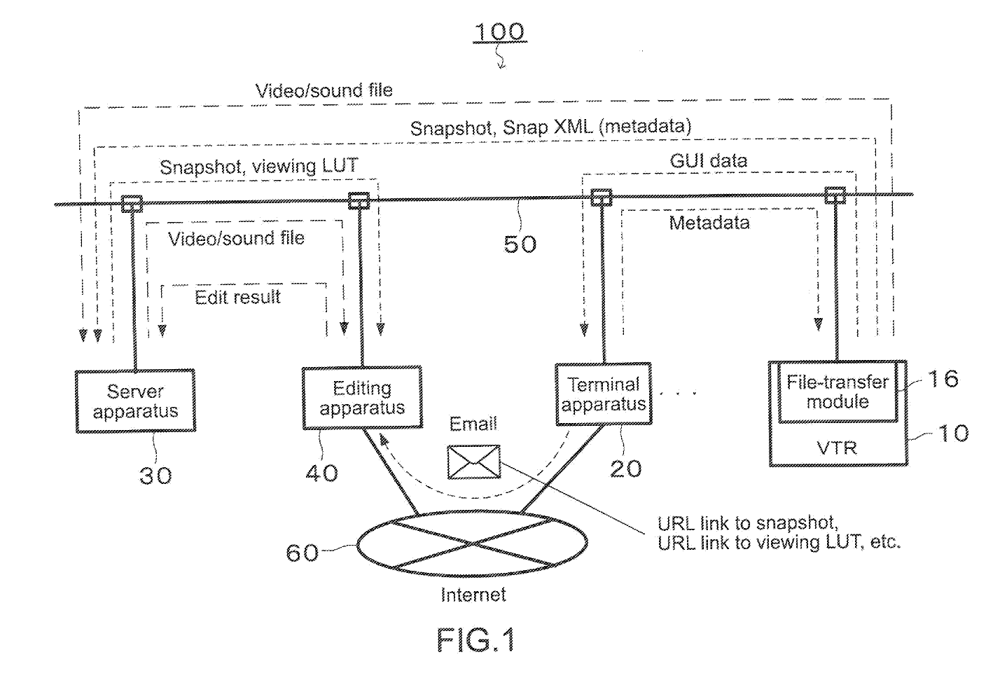

FIG. 1 is a block diagram showing the configuration of a filmmaking system according to the first embodiment of the present technology.

A filmmaking system 100 of this embodiment includes a VTR (Video Tape Recorder) 10, a terminal apparatus 20, a server apparatus 30, an editing apparatus 40, a local. area network 50 with which they are connected to each other, and the Internet 60.

The VTR 10 is an apparatus capable of recording video signals and sound signals took and recorded by a camera (not shown) in a tape, reproducing them, converting them into different formats, down-converting them, converting them to files, and the like. A file-transfer module 16 is mounted in the VTR 10 as an optional apparatus. The file-transfer module 16 is capable of transferring the files obtained by converting the video/sound signals by the VTR 10 to the server apparatus 30 via the local area network 50. The server apparatus 30 stores, in a determined shared directory, the files of video signals and sound signals transferred from the file-transfer module 16 of the VTR 10.

In the filmmaking system 100, a director views a video recorded in the tape of the VTR 10 and determines an arbitrary scene in the video and color modulation. information applied to the scene, and information on the scene and the color modulation information is transmitted to a user of the editing apparatus 40. The terminal apparatus 20 is an apparatus used by a director and the like in the above-mentioned the filmmaking system 100. Further, a plurality of terminal apparatuses 20 used by different users may exist in the filmmaking system 100 simultaneously. The terminal apparatus 20 may be a mobile apparatus because the field of a director is in a wide area in a filmmaking environment.

The file-transfer module 16 connected to the VTR 10 as an optional apparatus is capable of obtaining various kinds of Setup information from a user of the terminal apparatus 20 through an interactive communication by using GUIs (Graphical User Interface) with a user of the terminal apparatus 20.

The file-transfer module 16 (first GUI supplying unit) supplies GUI data (first GUI data) to the terminal apparatus 20. The GUI data (first GUI data) is data for causing a user of the terminal apparatus 20 to select an arbitrary scene in a video signal reproduced by a tape 70, color modulation information applied to the scene, and the like. The file-transfer module 16 performs color modulation of a selected scene with the color modulation information selected by a user by using the GUI data to thereby create an image as a snapshot. The file-transfer module 16 (metadata processing unit) is capable of creating metadata including access information necessary to access a file of a created snapshot, and storing the metadata in the server apparatus 30 connected via the local area network 50.

The file-transfer module 16 (second GUI supplying unit) obtains metadata stored in the server apparatus 30, obtains a snapshot based on access information included in the obtained metadata, creates GUI data (second GUI data) including the snapshot, and supplies the GUI data (second GUI data) to the terminal apparatus 20. The GUI data (second GUI data) includes a comment input box in which a user may input a comment. The file-transfer module 16 (comment processing unit) obtains a comment input to the comment input box, and uploads the comment to the server apparatus 30 such that the comment is added to metadata stored in the server apparatus 30.

The file-transfer module 16 (third GUI supplying unit) is capable of supplying GUI data (third GUI data) to the terminal apparatus 20. The GUI data (third GUI data) includes an environment for causing a user to create color modulation information.

The file-transfer module 16 (fourth GUI supplying unit) is also capable of supplying, when an arbitrary scene is selected by a user in the terminal apparatus 20, GUI data (fourth GUI data) to the terminal apparatus 20. The GUI data (fourth GUI data) includes an environment for editing and sending email. The email previously includes a first URL link to a snapshot and a second URL link to selected color modulation information applied to the scene.

The editing apparatus 40 is an apparatus such as, for example, a personal computer that assists postproduction works such as color grading of a video signal stored in the server apparatus 30. By referring to metadata stored in the server apparatus 30, the editing apparatus 40 is capable of easily generating an environment for reproducing, in the editing apparatus 40, a snapshot viewed by a user of the terminal apparatus 20 through a monitor.

Further, the editing apparatus 40 is capable of obtaining, by using a first URL link to a snapshot and a second URL link to color modulation information set in the body of email from the terminal apparatus 20, files of the snapshot and the color modulation information. As a result, it is possible to accurately and easily reflect the decision of a user of the terminal apparatus 20 on color grading of a video signal by the editing apparatus 40.

[Hardware Configuration of the VTR 10]

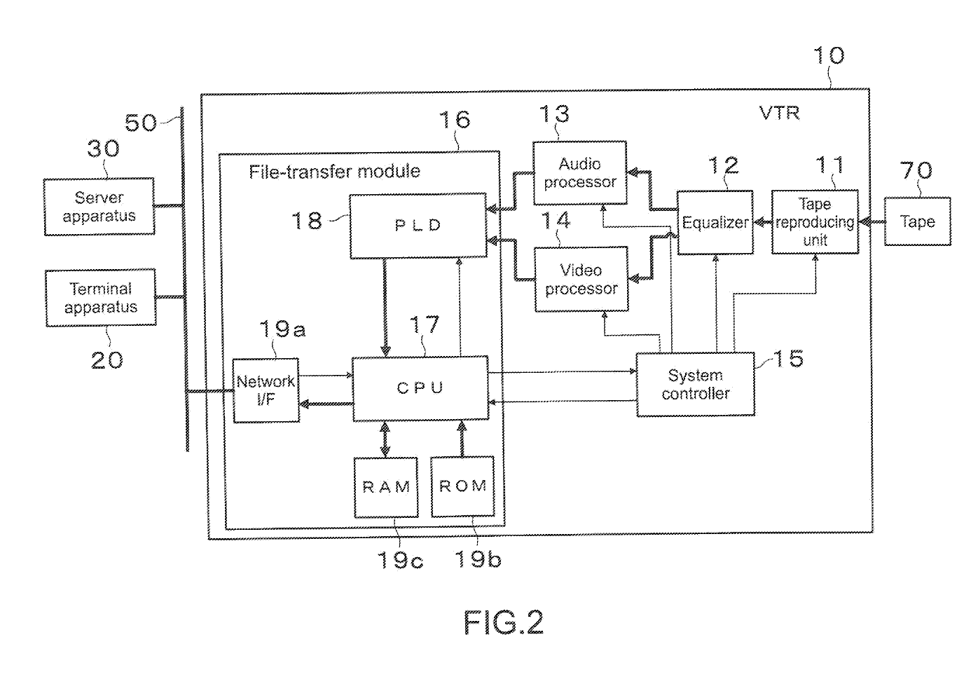

FIG. 2 is a diagram showing the configuration of the file-transfer module 16 and part of the configuration of the VTR 10.

The VTR 10 includes a tape reproducing unit 11, an equalizer 12, an audio processor 13, a video processor 14, a system controller 15, and the like.

The tape reproducing unit 11 reproduces video signals and sound signals recorded in the tape 70.

The equalizer 12 returns the frequency characteristic of a signal reproduced from the tape 70 by the tape reproducing unit 11 to the characteristic before being recorded in the tape 70.

The audio processor 13 performs various kinds of processing such as format conversion and file conversion of a sound signal output from the equalizer 12.

The video processor 14 performs various kinds of processing such as format conversion, file conversion, and down-conversion of a video signal output from the equalizer 12.

The system controller 15 sends/receives commands and statuses to/from a CPU 17 of the file-transfer module 16. The system controller 15 controls the tape reproducing unit 11, the equalizer 12, the audio processor 13, and the video processor 14 according to commands from the CPU 17 of the file-transfer module 16.

[Hardware Configuration of the File-Transfer Module 16]

The file-transfer module 16 includes the CPU (Central Processing Unit) 17, a PLD (Programmable Logic Device) 18, a network I/F 19a, a ROM (Read Only Memory) 19b, a RAM (Random Access Memory) 19c, and the like.

The PLD 18 converts sound files supplied from the audio processor 13 of the VTR 10 and video files supplied from the video processor 14 to formats transferrable through the local area network 50, and performs other processing.

The network I/F 19a is an interface to which the local area network 50 is connected.

The ROM 19b is storage in which programs executed by the CPU 17 and the like are stored.

The RAM 19c is storage used as a working space for the CPU 17.

Based on programs stored in the ROM 19b, the CPU 17 executes processing as the above-mentioned metadata processing unit, first GUI supplying unit, second GUI supplying unit, comment processing unit, third GUI supplying unit, and fourth GUI supplying unit.

[Configuration of the Terminal Apparatus 20]

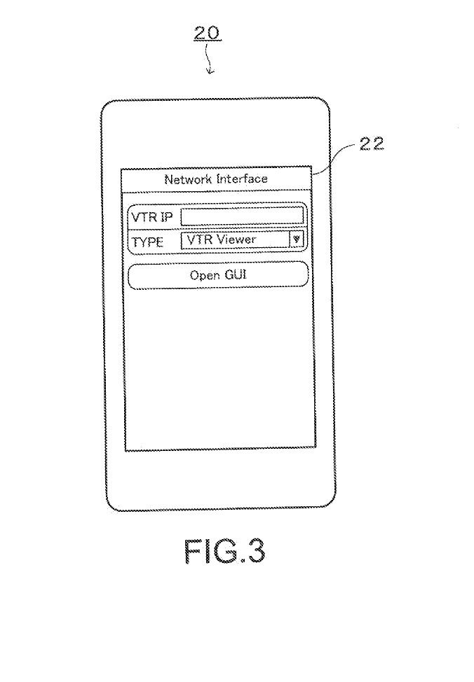

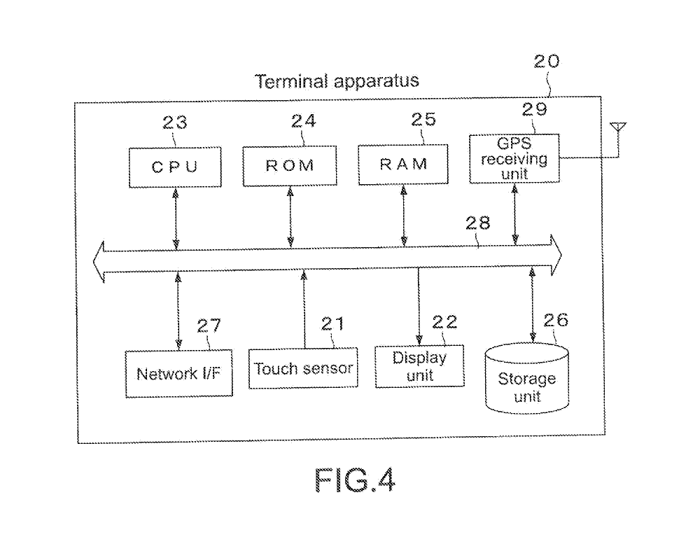

FIG. 3 is an external view showing the terminal apparatus 20, and FIG. 4 is a block diagram showing the hardware configuration of the terminal apparatus 20.

The terminal apparatus 20 is a mobile device or the like having a size that, for example, a user may grab the device with a hand and operate it. Further, the terminal apparatus 20 may be a laptop personal computer, a smart phone, or the like. The terminal apparatus 20 includes a display unit 22 including a monitor such as a liquid crystal display on which a touch sensor 21 is provided. An arbitrary position on the display unit 22 is touched with a finger of a user, and the touch sensor 21 detects coordinate data of the touched position and supplies the coordinate data to a CPU 23.

The terminal apparatus 20 includes the touch sensor 21, the display unit 22, the CPU 23, in addition, a ROM 24, a RAM 25, a storage unit 26, a network I/F 27, a bus 28, a GPS (Global Positioning System) receiving unit 29, and the like. The ROM 24 stores programs executed by the CPU 23 and other programs. The CPU 23 executes the programs stored in the ROM 24, and executes various control and arithmetic processing by using the RAM 25 as a working space. The storage unit 26 may store, for example, user data and the like. Further, the terminal apparatus 20 is capable of being connected to the local area network 50, the Internet 60, and the like via the network I/F 27. The GPS receiving unit 29 obtains latitude/longitude information of the terminal apparatus 20.

The server apparatus 30 and the editing apparatus 40 are configured by typical computer systems, respectively. The server apparatus 30 includes a CPU, a ROM, a RAM, a network I/F, and in addition, relatively high-capacity storage such as a hard disk drive. The storage stores video/sound files, Snap XML files, and the like transferred from the file-transfer module 16 of the VTR 10. The editing apparatus 40 includes a main body, a monitor, and input devices such as a mouse and a keyboard. The main body includes a CPU, a ROM, a RAM, storage, and a network I/F. A video edit program providing a video editing environment, an email client program, and the like are installed in the storage of the main body.

[Behavior of Filmmaking System]

Next, behaviors of the filmmaking system 100 of this embodiment will be described.

In the description of behaviors, GUIs displayed on the display unit 22 of the terminal apparatus 20 and operations with respect to the GUIs will mainly be described in the following order.

### 1. Homepage

### 2. VTR Setup

### 3. Disk Setup

### 4. VTR Viewer

5. Reference to snap list and comment edition
6. Sending email of metadata

[1. Homepage]

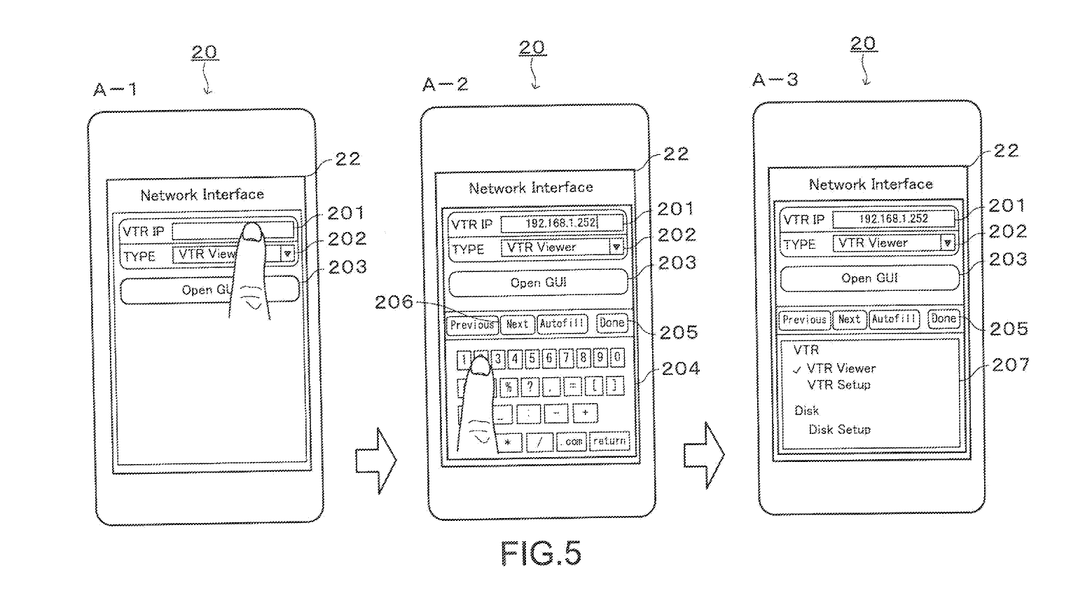

A-1 of FIG. 5 shows a homepage when setup necessary to operate the filmmaking system 100 is yet to complete in the terminal apparatus 20. The homepage includes a VTR IP input box 201, a window-type selection menu 202, an Open GUI button 203, and the like. In the homepage, the VTR IP input box 201 is blank, and an IP address allocated to the VTR 10 is set to the VTR IP input box 201.

In order to set an IP address of the VTR 10, as shown in A-1 of FIG. 5, first, a user touches the blank VTR IP input box 201. Then, as shown in A-2 of FIG. 5, a software keyboard 204 is displayed on the homepage. A user touches the software keyboard 204 to thereby input an IP address. The input IP address is displayed in the VTR IP input box 201. After an IP address is input, for example, the user touches a Done button 205 or the like to thereby complete setting of the IP address of the VTR 10.

The window-type selection menu 202 on the homepage is a menu for designating a window type of a window to be called from the homepage. In the window-type selection menu 202, “VTR Viewer” is set as a default. When a Next button 206 is touched in a state where the software keyboard 204 is displayed on the homepage, as shown in A-3 of FIG. 5, in place of the software keyboard 204, a window-type setting window 207 is displayed. The window-type setting window 207 is a window for setting a window type which may be selected in the window-type selection menu 202. As window types, “VTR Setup”, “Disk Setup”, and the like are employed, in addition to “VTR Viewer”. A user may select a window type to be registered in the window-type selection menu 202 by touching the window-type setting window 207 and the like. In the window-type setting window 207, a window type selected by a user is identified by a check mark. Therefore, the user may confirm a checked window type and select a window type at the same time. When the selection operation of a window type is completed, the user touches, for example, the

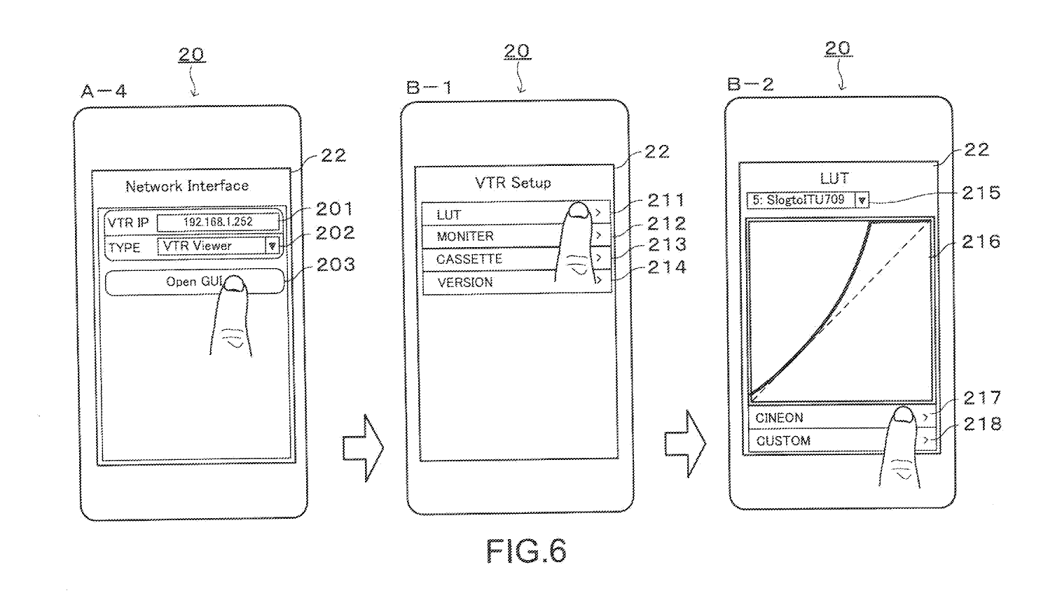

Done button 205 to thereby close the window-type setting window 207 and be in the state shown in A-4 of FIG. 6.

In order to operate the filmmaking system 100, VTR Setup and Disk Setup may be performed previously. Next, those VTR Setup and Disk Setup will be described.

[2. VTR Setup]

When “VTR Setup” is selected in the window-type selection menu 202 on the homepage shown in A-4 of FIG. 6 and the Open GUI button 203 is touched, the VTR Setup window of B-1 of FIG. 6 is displayed. On the VTR Setup window, an LUT button 211, a Monitor button 212, a Cassette button 213, and a Version button 214 are displayed. When the LUT button 211 is touched, an LUT menu window shown in B-2 of FIG. 6 is displayed.

Here, the LUT (Look up Table) will be described.

For example, a video (S-Log video) took by using an image-shooting gamma such as S-Log and recorded in the VTR is, when it is recorded in the hard disk drive or the like of the server apparatus, recorded as it is, or converted to Cineon space and recorded. The image-shooting gamma is designed in a nonlinear function so as to be capable of taking more shadow/highlight information.

By taking more shadow/highlight information, it is possible to increase degrees of freedom of color correction in a postproduction work. In a case of outputting an S-Log video on a monitor that executes processing in a linear space, as it is, the S-Log video is displayed as a dark picture. Therefore, the S-Log video is displayed through a viewing LUT for converting the S-Log video to the linear space and through a monitor LUT for indicating gamma characteristic of the monitor. As a result, it is possible to reproduce hues of colors of the S-Log video on a monitor as well as possible. Further, in a case of outputting a video (Cineon-Log video) obtained by converting an S-Log video to the Cineon space, on a monitor, similarly, the Cineon-Log video may be displayed on a monitor through a viewing LUT for converting the Cineon-Log video in the Cineon space to the linear space and through the monitor LUT.

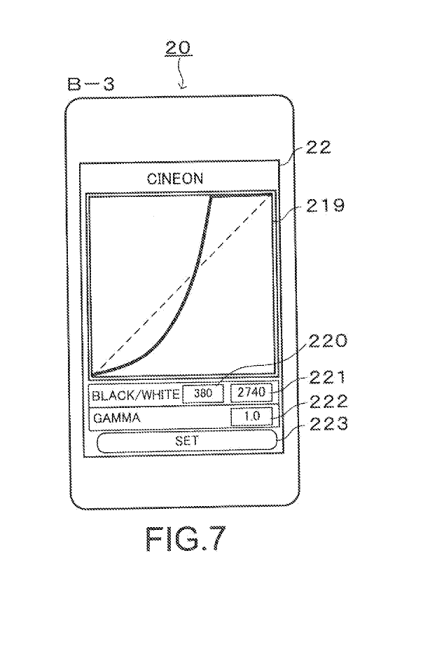

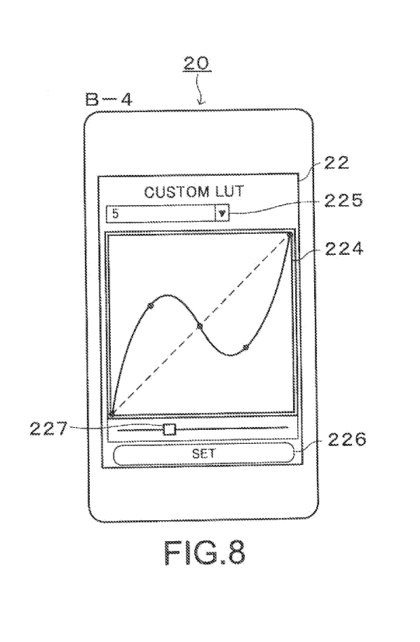

The LUT menu shown in B-2 of FIG. 6 will be described again. In the filmmaking system 100, a plurality of (for example, eight) viewing LUT files may be registered in the server apparatus 30 and the like. As shown in B-2 of FIG. 6, In the LUT menu, an LUT selection menu 215 for selecting a registered viewing LUT, a gamma curve display area 216 for displaying a gamma curve of an LUT selected by using the LUT selection menu 215, a Cineon button 217, and a Custom button 218 are displayed. Note that the gamma curve displayed in B-2 of FIG. 6 is a viewing LUT for converting an S-Log video to an ITU709 color space of a monitor. When the Cineon button 217 is touched, the Cineon LUT window shown in B-3 of FIG. 7 for creating a viewing LUT for converting a Cineon-Log video to an ITU709 color space of a monitor is displyed. Meanwhile, in a case where the Custom button 218 is touched, a Custom LUT window shown in B-4 of FIG. 8 for customizing and creating a new viewing LUT by a user is displayed.

On the Cineon LUT window (third GUI data), a gamma curve display area 219 for displaying a gamma curve of a viewing LUT for Cineon-Log video for converting a Cineon-Log video to an ITU709 color space of a monitor, a black-point input box 220, a white-point input box 221, a gamma-value input box 222, and a Set button 223 are displayed. Values input to the respect input boxes 220, 221, and 222 by a user are reflected on the shape of a gamma curve in the gamma curve display area 219. The user confirms the shape of the gamma curve in a gamma curve display area 219 and determines the gamma curve finally. After that, the user touches the Set button 223. As a result, a viewing-LUT file for Cineon-Log video is created and registered in the server apparatus 30 and the like. Note that the LUT file maybe registered in storage other than the server apparatus 30. For example, in a case where a device capable of reading/writing data out of/in a memory card is connected to the VTR 10, the LUT file may be registered in the memory card.

Here, in fact, the file-transfer module 16 of the VTR 10 creates a viewing LUT file for Cineon-Log video. That is, the file-transfer module 16 obtains data input to the Cineon LUT window by a user of the terminal apparatus 20 from the terminal apparatus 20 via the local area network 50, executes arithmetic processing by using the CPU 17 to thereby create a viewing LUT for Cineon-Log video, creates a file, and transfers the file to the server apparatus 30 and other storage to thereby cause them to store the file.

As described above, it is possible to create a viewing LUT for Cineon-Log video arbitrarily, and register the viewing LUT in the server apparatus and the like. Alternatively, a plurality of viewing LUTs for Cineon-Log video may be created and registered.

B-4 of FIG. 8 shows the Custom LUT window (third GUI data).

On the Custom LUT window, as an environment for creating a user-customized viewing LUT, a gamma curve setting area 224, a point-number selection menu 225, a Set button 226, and a slider 227 are displayed. in the gamma curve setting area 224, the spline curve of the gamma curve of the user-customized viewing LUT is displayed. In the point-number selection menu 225, a user is capable of selecting the number of points on the spline curve for determining the gamma curve at will. When the number of points is selected in the point-number selection menu 225, operational points are displayed on the spline curve. The number of the operational points is same as the selected number of points. For example, a user touches an operational point to be moved and performs a drag operation so as to move the operational point, operates the slider 227, and performs other operations whereby a desired gamma curve is create. When a desired gamma curve is determined and then a user touches the Set button 226, a file of the user-customized viewing LUT is created and registered in the server apparatus 30 and the like.

Here again, in fact, the file-transfer module 16 of the VTR 10 creates a user-customized viewing LUT. The file-transfer module 16 obtains data input to the Custom LUT window by a user of the terminal apparatus 20 from the terminal apparatus 20 via the local area network 50, executes arithmetic processing by using the CPU 17 to thereby create a user-customized viewing LUT, creates a file, and transfers the file to the server apparatus 30 and the like. As described above, it is possible to create a user-customized viewing LUT, and register the viewing LUT in the server apparatus and the like. Note that a plurality of user-customized viewing LUT may be created and registered.

Next, a case where the Monitor button 212 on a VTR

Setup window of B-1 of FIG. 6 is touched will be described. When the Monitor button 212 is touched, a Monitor window for setting a monitor LUT of the terminal apparatus 20 is displayed.

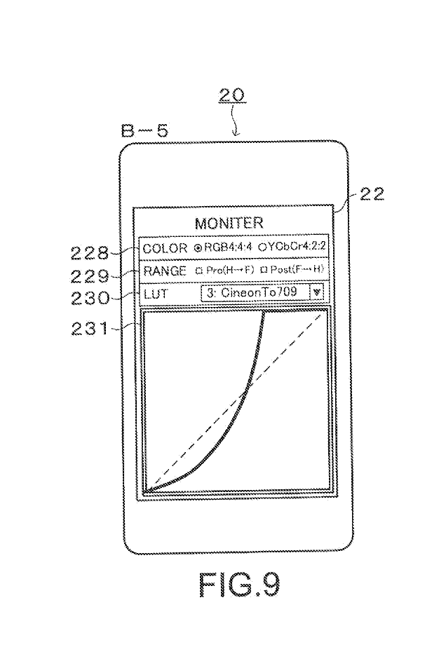

B-5 of FIG. 9 shows the Monitor window. On the Monitor window, Color radio buttons 228, video range check boxes 229, an LUT selection menu 230, an LUT-gamma-curve display area 231, and the like are displayed. The Color radio buttons 228 are radio buttons for selecting a color space of one of “RGB 4:4:4” and “YCbCr 4:2:2”. The video range check boxes 229 include two check boxes, that is, “Pro (H to F)” and “Post (F to H)”. “Pro (H to F)” is a box to be checked in a case where the video range is to be converted from the limited range to the full range and then converted by using the viewing LUT. “Post (F to H)” is a box to be checked in a case where the video range is to be returned from the full range to the limited range after conversion by using the viewing LUT is performed. The LUT selection menu 230 is a menu for selecting a monitor LUT to be used by the terminal apparatus 20. In the LUT-gamma-curve display area 231, a gamma curve of a monitor LUT selected in the LUT selection menu 230 is displayed.

Next, a case where the Cassette button 213 on the. VTR Setup window of B-1 of FIG. 6 is touched will be described. When the Cassette button 213 is touched, a Cassette menu is displayed.

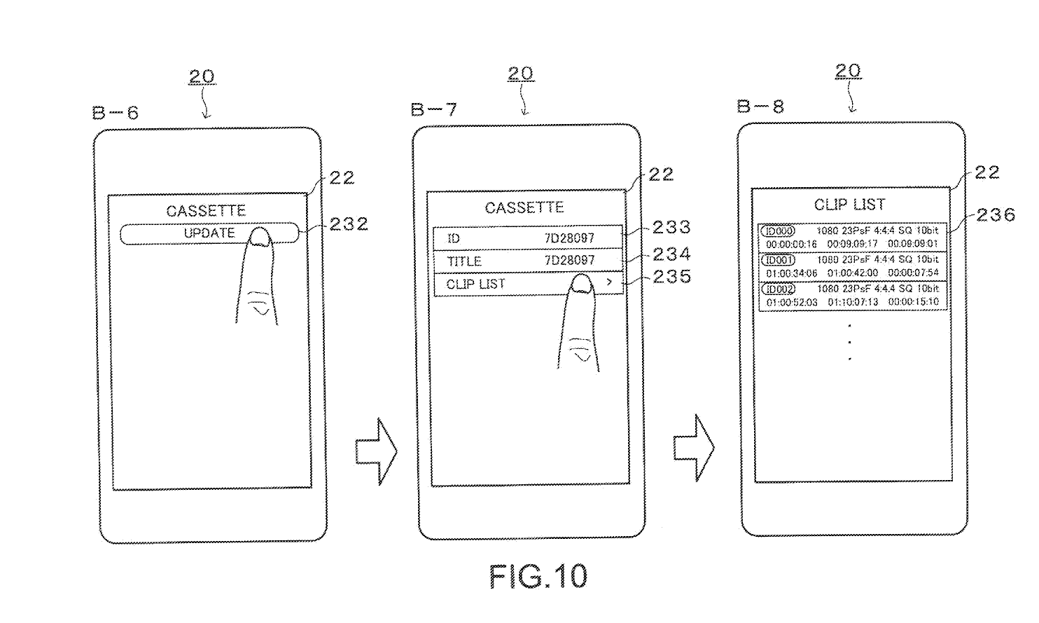

B-6 of FIG. 10 shows the Cassette menu window. On the Cassette menu window, an Update button 232 is displayed. When a user touches the Update button 232, the terminal apparatus 20 sends a request to obtain information on a cassette of the tape 70 set in the VTR 10, to the file-transfer module 16 of the VTR 10. Then, the VTR 10 replies information on the cassette ID, the title, and the like to the terminal apparatus 20.

B-7 of FIG. 10 shows a Cassette information window on which information on the cassette ID, the title, and the like replied from the VTR 10 are displayed. On the Cassette information window, in addition to the information on a cassette ID 233, a title 234, and the like, a Clip List button 235 is displayed. When a user touches the Clip List button 235, the terminal apparatus 20 sends a Clip List request to the VTR 10, and the VTR 10 sends a Clip List as a reply.

B-8 of FIG. 10 shows a Clip List window. The Clip List 236 is a list of information on each clip being a video of each scene recorded in a cassette. Information on each clip includes a clip ID, a format, a start time code, an end time code, a length, and the like.

[3. Disk Setup]

Next, Disk Setup will be described. Here, Disk means the shared directory of the server apparatus 30.

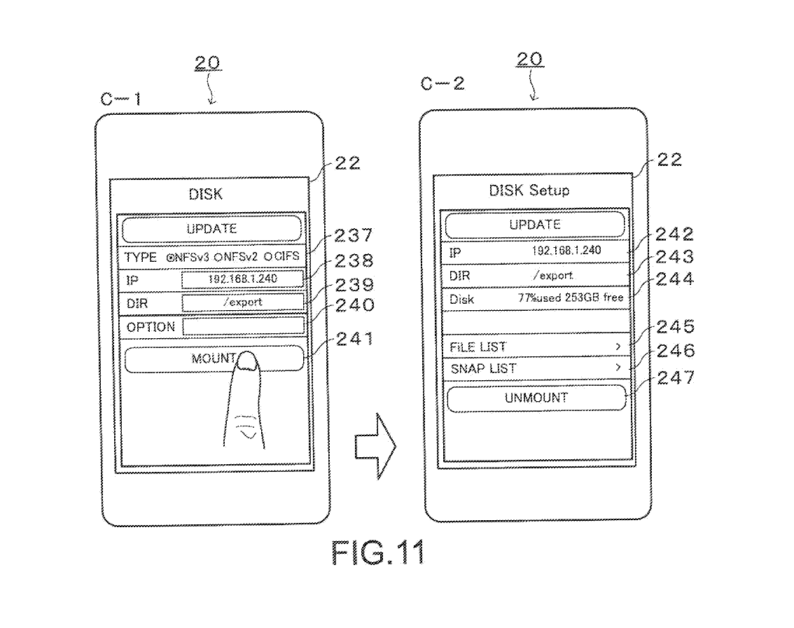

When “Disk Setup” is selected in the window-type selection menu 202 on the homepage shown in A-1 of FIG. 5 and then the Open GUI button 203 is touched, a Disk Setup window shown in C-1 of FIG. 11 is displayed. On the Disk Setup window, type radio buttons 237, an IP input box 238, a Dir input box 239, an Option input box 240, and a Mount button 241 are displayed.

The Type radio buttons 237 are for selecting, by a user, the kind of network file-sharing system such as NFSv3 (Network File System version 3), NFSv2 (Network File System version 2), or CIFS (Common Internet File System). The IP input box 238 is a box to which an IP address of the server apparatus 30 is input. To the Dir input box 239, a directory of a location in which data is stored in the server apparatus 30 is input. To the Option input box 240, a mount option is input. Input to each of the input boxes 237-240 is performed by using a software keyboard displayed when a user touches each of the input boxes.

When necessary information is input to the Type radio buttons 237, the IP input box 238, the Dir input box 239, the Option input box 240, and the like, and then a user touches the Mount button 241, mount of the server apparatus 30 is completed. After that, the VTR 10 is capable of accessing a certain directory of the server apparatus 30 via the local area network 50. As a result, the VTR 10 is capable of transferring a video/sound file, a Snap XML file, and the like for each clip unit to a certain directory of the server apparatus 30.

C-2 of FIG. 11 shows the Disk Setup window after the mount of the server apparatus 30 is completed. On the Disk Setup window after the mount of the server apparatus 30 is completed, an IP address 242 of the server apparatus 30, a directory 243, a disk space 244, and the like are displayed. In addition, a File List button 245, a Snap List button 246, an Unmount button 247, and the like are displayed.

When a user touches the File List button 245, a list of information on clips stored in a certain directory of the server apparatus 30 is displayed as a File List. When a user designates a clip to be viewed in the File List, a clip viewer is started, and the user is capable of viewing the designated clip.

Behaviors in a case where a user touches the Snap List button 246 will be described later.

In a case where a user touches the Unmount button 247, the directory of the server apparatus 30 being displayed is unmounted. Further, in a case where a network shared directory is to be set in storage other than the server apparatus 30 such as, for example, a memory card, necessary information may be set in the Disk Setup window again and the directory may be mounted.

[4. VTR Viewer]

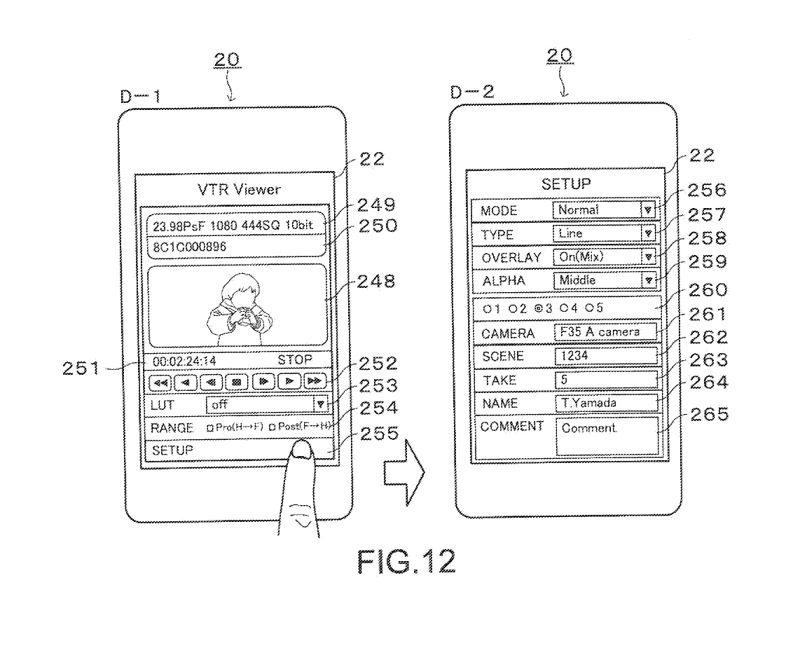

Next, the VTR Viewer will be described. The VTR Viewer is a viewer capable of reproducing videos recorded in the tape 70 of the VTR 10 for each clip unit. When “VTR Viewer” is selected in the window-type selection menu 202 on the homepage shown in A-1 of FIG. 5 and the Open GUI button 203 is touched, a VTR Viewer window (first GUI data) shown in D-1 of FIG. 12 is displayed. On the VTR Viewer window, a viewer area 248 In which a video is displayed, a video format 249 of a clip being reproduced, a cassette ID 250, a time code 251, viewer operational buttons 252, an LUT selection menu 253, video range check boxes 254, a Setup button 255, and the like are displayed.

The viewer operational buttons 252 include a plurality of operational buttons for reproducing, stopping, forwarding, rewinding, skip-forwarding, skip-rewinding, fast-forwarding, and fast-rewinding a clip displayed on the viewer area 248, and the like. When a user touches the viewer operational buttons 252, a command corresponding to the kind of the touched button is sent to the VTR 10, and the VTR 10 executes the command. As a result, the time of the video displayed by the terminal apparatus 20 is changed.

The LUT selection menu 253 is a menu for selecting a viewing LUT to be applied to a clip on the viewer area 248 being viewed by a user. Viewing LUTs displayed on the LUT selection menu 253 as candidates are a viewing LUT for an S-Log video, a viewing LUT for a Cineon-Log video, a user-customized viewing LUT, and the like. A user may arbitrarily select a viewing LUT such that the clip on the viewer area 248 being viewed by the user is displayed with colors that the user decided. The video range check boxes 254 include two check boxes, that is, “Pro (H to F)” and “Post (F to H)”. “Pro (H to F)” is a box to be checked in a case where the video range is to be converted from the limited range to the full range and then converted by using the viewing LUT. “Post (F to H)” is a box to be checked in a case where the video range is to be returned from the full range to the limited range after conversion by using the viewing LUT is performed. In order to be displayed with colors that the user decided, the user may check each of the two check boxes individually. Here, information on the selected viewing LUT and video range is “color modulation information” of the present technology. Note that, in the present technology, the color modulation information may be information on one of the viewing LUT and the video range.

When the Setup button 255 is touched by a user, a setup window for setting the VTR Viewer is displayed.

D-2 of FIG. 12 shows a VTR Viewer setup window. On the VTR Viewer setup window, a Mode selection menu 256, a waveform-type selection menu 257, an overlay-mode selection menu 258, an overlay-alpha-level selection menu 259, and a priority selection menu 260 are displayed. Here, the priority is a priority between users. The priority may be changed between, for example, five stages of “1” to “5”. Further, on the VTR Viewer setup window, a camera-number input box 261, a scene-number input box 262, a take-number input box 263, a user-name input box 264, a comment input box 265, and the like are displayed. Here, information input to each of the camera-number input box 261, the scene-number input box 262, the take-number input box 263 is used as image-shooting log information.

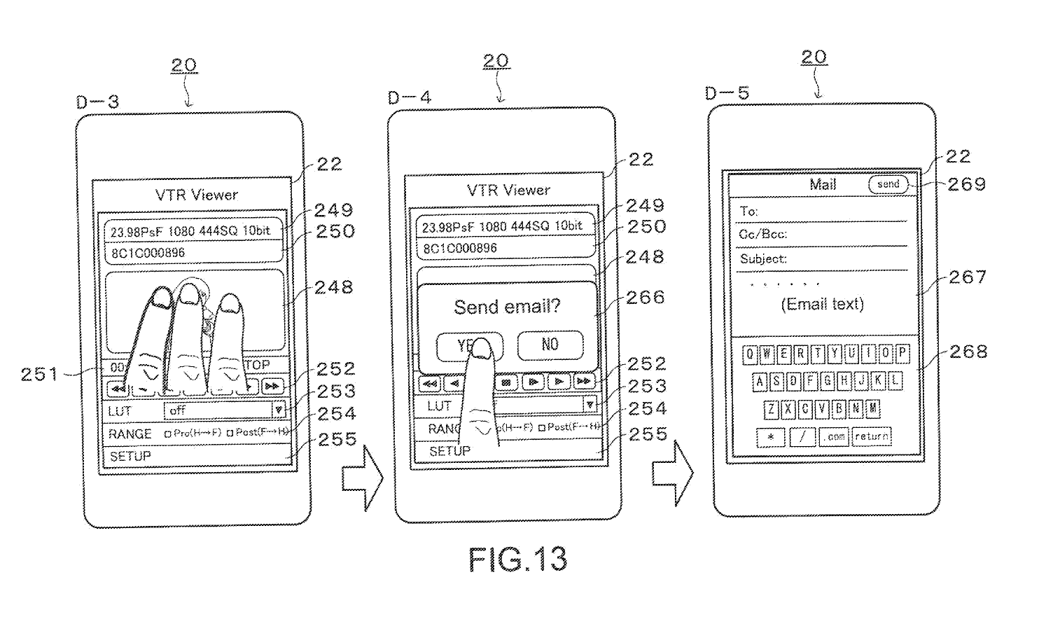

As shown in D-3 of FIG. 13, when a predetermined operation is executed, for example, when a user simultaneously touches three points in the viewer area 248 with his fingers, the terminal apparatus 20 sends a snapshot request to the file-transfer module 16 of the VTR 10. The snapshot request includes the following metadata.

Latitude/longitude

Time code

Viewing LUT name

Viewing LUT location

Monitor LUT name

Monitor LUT location

Video range information

IP address of terminal apparatus

User priority

Image-shooting log (camera name, scene number, take number)

User name of terminal apparatus

Comment

When the file-transfer module 16 (metadata processing unit) of the VTR 10 receives a snapshot request including the above-mentioned metadata, the file-transfer module 16 (metadata processing unit) of the VTR 10 obtains a viewing LUT file based on the viewing LUT name and location in the metadata included in the snapshot request. Based on the obtained viewing LUT file and video range information, the file-transfer module 16 creates a snapshot file which is bitmap-format or JPEG-format image data of a frame corresponding to the time code included in the snapshot request. The file-transfer module 16 creates a Snap XML file, and transfers the Snap XML file and the above-mentioned snapshot file to the shared directory of the server apparatus 30. In the Snap XML file, the above-mentioned respective metadata included in the snapshot request obtained from the terminal apparatus 20, various metadata managed in the VTR 10, and in addition, snapshot location information (access information) are described in the XML format. After that, the file-transfer module 16 notifies the terminal apparatus 20 that the Snap XML file has been transferred.

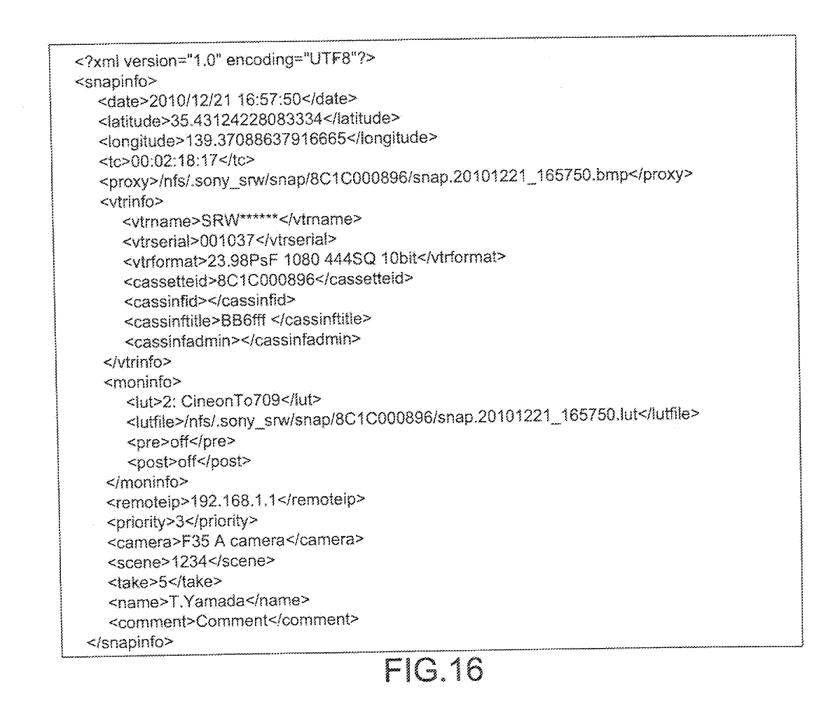

FIG. 16 is a diagram showing an example of Snap XML.

As shown in FIG. 16, the Snap XML includes a date element for setting date and time, a latitude element for setting a latitude, a longitude element for setting longitude, a TC element for setting a time code, a proxy element for setting snapshot location information, a vtrinfo element for setting information on the VTR 10, a moninfo element for setting information on the monitor of the terminal apparatus 20, a remoteip element for setting the IP address of the terminal apparatus, a priority element for setting a priority, a camera element for setting a camera name, a scene element for setting a scene number, a take element for setting a take number, a name element for setting a user name, and a comment element for setting a comment. The vtrinfo element includes, as subelements, a vtrname element for setting the name of the VTR 10, a vtrserial element for setting an identification number of the VTR 10, a vtrformat element for setting video format information, a cassetteid element for setting a cassette ID of the tape 70 set in the VTR 10, a cassettetitle element for setting a cassette title, and the like. The moninfo element includes, as subelements, an lut element for setting a monitor LUT name, an lutfile element for setting a monitor LUT location, a pre element and a post element for setting video range information, and the like. Note that the example of Snap XML of FIG. 16 does not include an element with regard to a viewing LUT. However, the Snap XML may include an element with regard to a viewing LUT.

[5. Reference of Snap List and Comment Edit]

Next, reference of snap list and comment edit will be described.

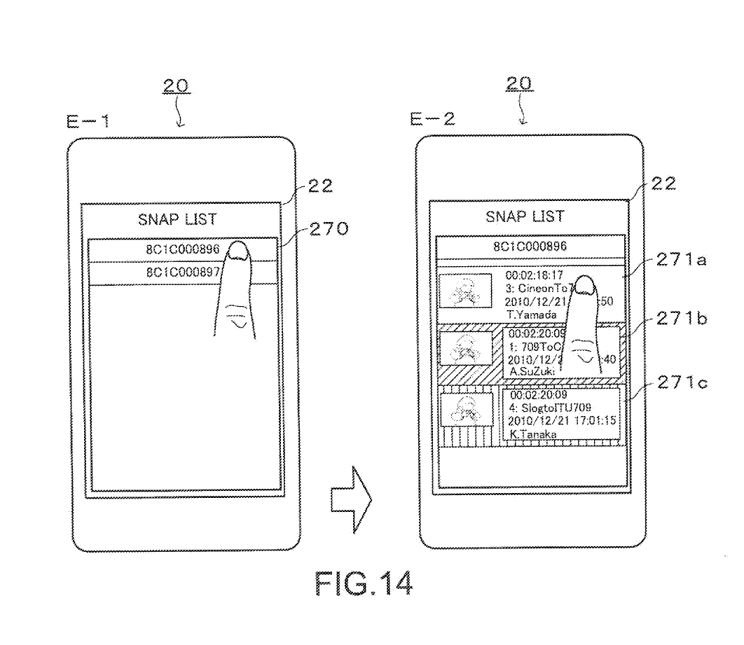

When a user touches the Snap List button 246 on the Disk Setup window shown in C-2 of FIG. 11, as shown in E-1 of FIG. 14, a Snap List window is displayed. On the Snap List window, a cassette ID list 270 is displayed. Here, the VTR 10 obtains Snap XML files stored in the server apparatus 30, and searches all the obtained Snap XML files for the cassette ID.

A user may touch one cassette ID in the cassette ID list 270 to thereby select the cassette ID. When one cassette ID is selected, as shown in E-2 of FIG. 14, a Snap-List window (second GUI data) is displayed. In the Snap List window, a low-resolution image of a snapshot, a time code, a viewing LUT, a creation date and time, a user name, and the like for each snapshot connected to a selected cassette ID are displayed as each of the snapshot information 271a, 271b, and 271c.

The Snap List window shown in E-2 of FIG. 14 is an example of a case where three snapshots are included in the same scene. In this example, user names of the three snapshots are different from each other. So it is understood that those snapshots are created based on snapshot requests from users of the different terminal apparatuses 20. Further, in the example of the Snap List window, three users select different viewing LUTs with regard to the same scene, respectively.

Further, the Snap List window employs a display mode with which a user may understand a rank relationship of user priorities at a glance. For example, the higher the priority of a user is, the lighter the color of the background of the display area of each of the snapshot information 271a, 271b, and 271c. Further, the snapshot information of a user having a higher priority may be arranged in an upper position in the window.

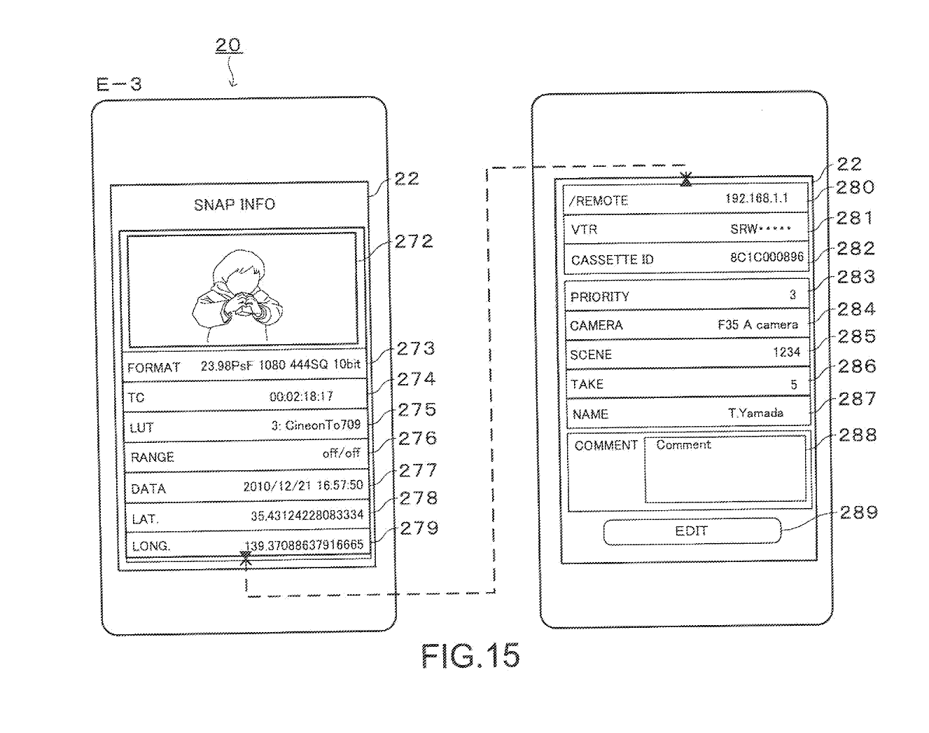

When one snapshot is selected by touching a display area of one snapshot information (for example, 271a) in the Snap-List window shown in E-2 of FIG. 14 or by other operations, as shown in E-3 of FIG. 15, a Snap-Info window (second GUI data) for displaying detailed data of the snapshot is displayed.

As shown in E-3 of FIG. 15, in the Snap-Info window, a snapshot image 272, a video format 273, a time code 274, a viewing LUT name 275, video range information 276, a snapshot creation date and time 277, a latitude 278, a longitude 279, an IP address of the terminal apparatus 20 208, a VTR name 281, a cassette ID 282, a user priority 283, a camera name 284, a scene number 285, a take number 286, a user name 287, and the like are displayed. Further, in the Snap-Info window, a comment input box 288 is provided, and a comment of a user as a snapshot creator is displayed in the comment input box 288. Further, by touching the comment input box, a software keyboard is displayed. Through touch operations of the software keyboard, a user may edit (amend, delete, add, and the like) comments in the comment input box 288. Further, in the Snap-Info window, an Edit button 289 is provided. When a user touches the Edit button 289, an edit result in the comment input box 288 is sent to the file-transfer module 16.

[6. Sending Email of Metadata]

The terminal apparatus 20 receives a notification that a Snap XML file has been transferred from the file-transfer module 16. Then, as shown in D-4 of FIG. 13, the terminal apparatus 20 displays a pop-up 266 on the VTR Viewer window. The pop-up 266 is a pop-up for encouraging a user to send email to the editing apparatus 40. When a user performs an operation to agree to send email to the editing apparatus 40 on the pop-up 266, an email sending window (fourth GUI data) is displayed.

D-5 of FIG. 13 shows an email sending window. On the email sending window, together with an email text 267, a software keyboard 268 and the like are displayed. The email text 267 includes the following information at first.

Date and time

Latitude/longitude of terminal apparatus

Video format

Cassette ID

Time code

Shared directory of snapshot

Snapshot location

First URL link to snapshot

Viewing LUT name

Second URL link to viewing LUT

Video range information

Image-shooting log (camera name, scene number, take number)

Comment

A user may edit information on the respective items and the comment in the email sending window as necessary. Finally, a Send button 269 in the email sending window is touched, whereby email is sent to the editing apparatus 40.

A user of the editing apparatus 40 that has received the email may confirm the email text and reflect it on edit works such as color grading of a video. In the email text, the first URL link to the snapshot and the second URL link to the viewing LUT are set. So, by using those URL links, an editor may download a snapshot file and a viewing LUT file. As a result, information on colors decided by a director may be transmitted to an edit environment promptly, and edit works such as color grading may be performed efficiently.

[Description of Behaviors]

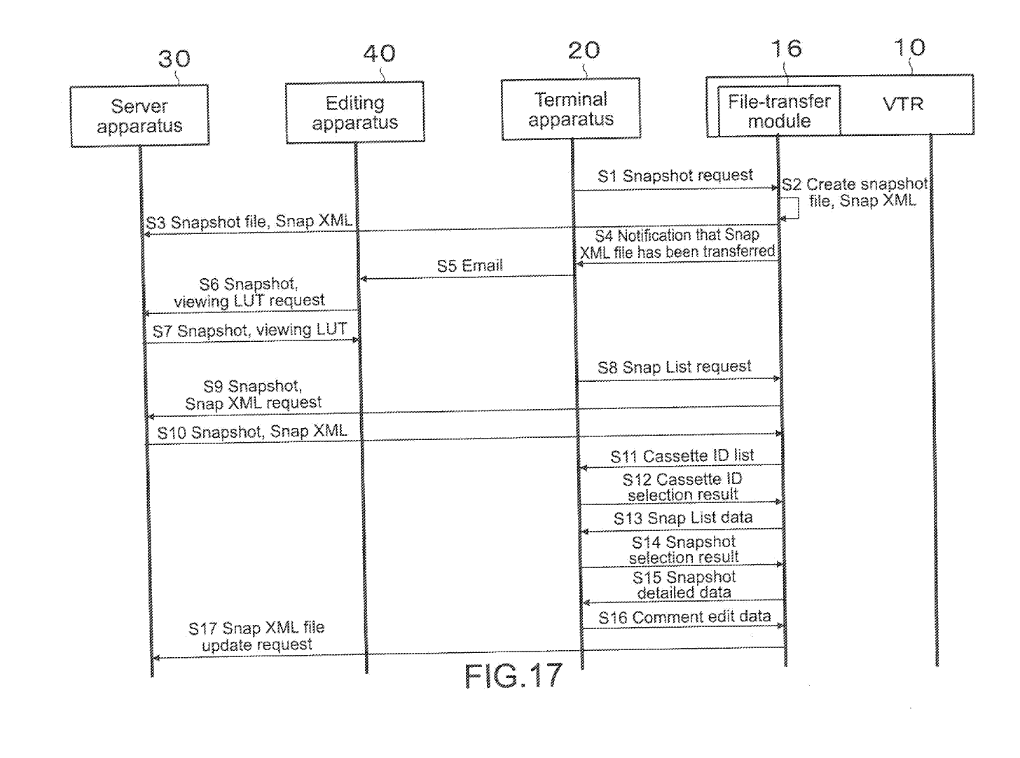

Next, behaviors of the filmmaking system 100 after the terminal apparatus 20 sends a snapshot request to the file-transfer module 16 will be described with reference to FIG. 17.

When the file-transfer module 16 of the VTR 10 receives a snapshot request (Step S1), the file-transfer module 16 obtains a viewing LUT file based on access information such as a name and a location of a viewing LUT included in the snapshot request and other information. Based on information on the obtained viewing LUT file and video range, the file-transfer module 16 creates a snapshot file which is bitmap-format or JPEG-format image data of a frame corresponding to a time code included in the snapshot request (Step S2).

Next, the file-transfer module, 16 creates a Snap XML file, and transfers the Snap XML file and the above-mentioned snapshot file to the shared directory of the server apparatus 30. In the Snap XML file, the above-mentioned respective information included in the snapshot request, various information on the VTR 10, and in addition, snapshot location information are described (Step S3). After that, the file-transfer module 16 (metadata processing unit) notifies the terminal apparatus 20 that the Snap XML file has been transferred (Step S4).

After the terminal apparatus 20 receives the notification that the Snap XML file has been transferred, the terminal apparatus 20 displays the pop-up 266. When a user performs an operation to agree to send email on the pop-up 266, an email sending window is displayed. The comment is edited and and other operations are performed as necessary in the email sending window, and after that, email is sent to the editing apparatus 40 (Step S5).

A user of the editing apparatus 40 receives email, and then, obtains a snapshot file and a viewing LUT file by using URL links set in the received email (Steps S6, S7). At the same time, the user of the editing apparatus 40 may confirm the monitor LUT set to the monitor of the terminal apparatus 20 based on the metadata stored in the server apparatus 30, and set the same monitor LUT to the monitor of the editing apparatus 40. As a result, a snapshot having hues same as the hues of the monitor of the terminal apparatus 20 is reproduced on the monitor of the editing apparatus 40. That is, the colors that the user of the terminal apparatus 20 decided are transmitted to the edit environment accurately.

Next, behaviors in a case where a user touches the Snap List button 246 in the Disk Setup window shown in C-2 of FIG. 11 will be described with reference to FIG. 17.

When a user touches the Snap List button 246, a Snap List request is sent to the file-transfer module 16 (Step S8).

When the file-transfer module 16 receives the Snap List request, the file-transfer module 16 obtains all the snapshot files and Snap XML files from the server apparatus 30 (Steps S9, S10). The file-transfer module 16 creates a cassette ID list based on the obtained snapshot file and Snap XML file, and sends the cassette ID list to the terminal apparatus 20 (Step S11).

The terminal apparatus 20 sends a cassette ID, which is selected by a user out of the cassette ID list, to the file-transfer module 16 (Step S12). The file-transfer module 16 creates a Snap List data based on all the snapshot files and Snap XML files connected to the obtained cassette ID, and sends the Snap List data to the terminal apparatus 20 (Step S13).

The terminal apparatus 20 sends, to the file-transfer module 16, information on one snapshot selected from the Snap-List window displayed based on the Snap List data by a user (Step S14). The file-transfer module 16 sends detailed data of the selected snapshot to the terminal apparatus 20 (Step S15).

A user edits a comment in the comment input box 288 in the Snap-Info window displayed based on the detailed data of the snapshot. After that, the terminal apparatus 20 sends the comment edit result to the file-transfer module 16 (Step S16). The file-transfer module 16 (comment processing unit) sends, to the server apparatus 30, a request to update a Snap XML file including the comment edit result sent from the terminal apparatus 20 (Step S17). Then, the server apparatus 30 updates the comment of the stored Snap XML file according to the update request of the Snap XML file.

As described above, according to this embodiment, the following effects are obtained.

1. The terminal apparatus 20 is capable of selecting an arbitrary scene in a video signal recorded in the tape 70 and color modulation information applied to the scene.

2. Metadata including access information to a snapshot of a video scene, to which a color modulation is applied based on color modulation information, is stored in the server apparatus. As a result, a user may refer to the metadata by using an apparatus capable of accessing the server apparatus as needed. Therefore, for example, a user of the editing apparatus 40 refers to metadata stored in the server apparatus 30, whereby an editing apparatus is capable of easily generating an environment for reproducing a snapshot that a user of the terminal apparatus 20 viewed through a monitor. As a result, it is possible to accurately reflect the decision of the user of the terminal apparatus on color grading of a video signal by the editing apparatus.

3. In a case where snapshots of a plurality of users of the same scene are displayed in the Snap List window, display areas of the respective snapshots are displayed in a mode with which a user may understand a rank relationship of user priorities at a glance. Therefore, a user may promptly decide to reflect colors, which a certain user decided, on edit works in consideration of the user priorities.

4. By using a first URL link to a snapshot file and a second URL link to a color modulation information file set in a body of email received from the terminal apparatus 20, those files may be obtained. As a result, the decision of a user of the terminal apparatus 20 may be accurately and easily reflected on color grading of a video signal by the editing apparatus 40.

Note that the present technology may employ the following configurations.

(1) A reproduction apparatus, comprising:

a reproduction unit configured to reproduce, from a recording medium that records a video signal, the video signal;

a first GUI supplying unit configured to supply first GUI data to a terminal apparatus connected via a network, the first GUI data being data for causing a user to select an arbitrary scene in the reproduced video signal and color modulation information applied to the scene; and

a metadata processing unit configured to perform color modulation of the selected scene with the selected color modulation information to thereby create an image as a snapshot, and to store metadata in a server apparatus connected via the network, the metadata including access information necessary to access the snapshot.

(2) The reproduction apparatus according to (1), further comprising:

a second GUI supplying unit configured to obtain the metadata stored in the server apparatus via the network, to obtain a snapshot based on the access information included in the obtained metadata, to create second GUI data including the snapshot, and to supply the second GUI data to the terminal apparatus.

(3) The reproduction apparatus according to (1) or (2), wherein

the metadata further includes information identifying an LUT (Look up Table) of a monitor of the terminal apparatus.

(4) The reproduction apparatus according to (2) or (3), wherein

the metadata further includes a user name of the terminal apparatus, and information on a priority of a user, and

the second GUI supplying unit is configured to create, in a case of obtaining a plurality of pieces of metadata of a plurality of users, second GUI data in a display mode to which priorities of the plurality of users are added.

(5) The reproduction apparatus according to any one of (2) to (4), wherein

the second GUI data includes a comment input box in which a user may input a comment, and

the reproduction apparatus further comprises a comment processing unit configured to obtain a comment input to the comment input box, and to upload the comment to the server apparatus so as to add the comment to the metadata.

(6) The reproduction apparatus according to any one of (1) to (5), further comprising:

a third GUI supplying unit configured to supply third GUI data to the terminal apparatus, the third GUI data having an environment causing the user to create new color modulation information.

(7) The reproduction apparatus according to any one of (1) to (6), further comprising:

a fourth GUI supplying unit configured to supply, in a case where an arbitrary scene is selected in the terminal apparatus by the user, fourth GUI data to the terminal apparatus, the fourth GUI data having an environment for editing and sending email to an editing apparatus configured to edit the video signal, the email previously including at least a first URL link, to the snapshot and a second URL link to the color modulation information selected so as to be applied to the scene.

(8) The reproduction apparatus according to any one of (1) to (7), wherein

the color modulation information includes at least a viewing LUT.

The present disclosure contains subject matter related to that disclosed in Japanese Priority Patent Application JP 2011-085343 filed in the Japan Patent Office on Apr. 7, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reproduction apparatus, comprising:
a reproduction unit configured to reproduce, from a recording medium that records a video signal, the video signal;
a first GUI supplying unit configured to supply first GUI data to a terminal apparatus connected via a network, the first GUI data being data for causing a user to select an arbitrary scene in the reproduced video signal and color modulation information applied to the scene; and
a metadata processing unit configured to perform color modulation of the selected scene with the selected color modulation information to thereby create an image as a snapshot, and to store metadata in a server apparatus connected via the network, the metadata including access information necessary to access the snapshot.

2. The reproduction apparatus according to claim 1, further comprising:
a second GUI supplying unit configured to obtain the metadata stored in the server apparatus via the network, to obtain a snapshot based on the access information included in the obtained metadata, to create second GUI data including the snapshot, and to supply the second GUI data to the terminal apparatus.

3. The reproduction apparatus according to claim 2, wherein
the metadata further includes information identifying an LUT (Look up Table) of a monitor of the terminal apparatus.

4. The reproduction apparatus according to claim 3, wherein
the metadata further includes a user name of the terminal apparatus, and information on a priority of a user, and
the second GUI supplying unit is configured to create, in a case of obtaining a plurality of pieces of metadata of a plurality of users, second GUI data in a display mode to which priorities of the plurality of users are added.

5. The reproduction apparatus according to claim 4, wherein
the second GUI data includes a comment input box in which a user may input a comment, and
the reproduction apparatus further comprises a comment processing unit configured to obtain a comment input to the comment input box, and to upload the comment to the server apparatus so as to add the comment to the metadata.

6. The reproduction apparatus according to claim 5, further comprising:
a third GUI supplying unit configured to supply third GUI data to the terminal apparatus, the third GUI data having an environment causing the user to create new color modulation information.

7. The reproduction apparatus according to claim 6, further comprising:
a fourth GUI supplying unit configured to supply, in a case where an arbitrary scene is selected in the terminal apparatus by the user, fourth GUI data to the terminal apparatus, the fourth GUI data having an environment for editing and sending email to an editing apparatus configured to edit the video signal, the email previously including at least a first URL link to the snapshot and a second URL link to the color modulation information selected so as to be applied to the scene.

8. The reproduction apparatus according to claim 7, wherein
the color modulation information includes at least a viewing LUT.

9. A filmmaking system, comprising:
a reproduction apparatus including a reproduction unit configured to reproduce, from a recording medium that records a video signal, the video signal, and to create a file of the video signal;
a terminal apparatus connected to the reproduction apparatus via a network;
a server apparatus capable of storing the file of the video signal created by the reproduction apparatus; and
an editing apparatus configured to obtain the file of the video signal stored in the server apparatus, and to edit the video signal, wherein
the reproduction apparatus includes
a GUI supplying unit configured to supply first GUI data to the terminal apparatus, the first GUI data being data for causing a user to select an arbitrary scene in the reproduced video signal and color modulation information applied to the scene, and
a metadata processing unit configured to perform color modulation of the selected scene with the selected color modulation information to thereby create an image as a snapshot, and to store metadata in a server apparatus connected via the network, the metadata including access information necessary to access the snapshot, and
the terminal apparatus includes
a monitor configured to display the first GUI data supplied from the reproduction apparatus, and
an input unit configured to accept selection by the user.
